(19) United States
(12) Patent Application Publication
(10) Pub. No.: US 2010/0054566 A1
(43) Pub. Date: Mar. 4, 2010

(54) MEDICAL IMAGE MANAGEMENT SYSTEM

(75) Inventor: Haruyuki Toda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC., Hino-shi, Tokyo (JP)

(21) Appl. No.: 12/519,727

(22) PCT Filed: Nov. 21, 2007
(86) PCT No.: PCT/JP2007/072515

§ 371 Date: Jun. 17, 2009

(30) Foreign Application Priority Data
Dec. 19, 2006 (JP) 2006-340851

(51) Int. Cl. G06K 9/00; G06Q 50/00; G06F 3/048

(52) U.S. Cl. 382/131; 705/3; 715/772

(57) ABSTRACT

In a medical image management system, the network load can be reduced and the network resources can be effectively used. A console (6) transmits status update instruction information corresponding to the progress status of photographing by a modality (5) to a server (2). The server (2) updates the status information of list data according to the received status update instruction information and transmits the updated list data to a viewer (3). The console (6) temporally stores medical image data generated by the modality (5) and transfers the temporally stored medical image data to the viewer (3) in response to a transmission instruction from the viewer (3). The console (6) also transfers the all temporally stored medical image data to the server (2) at a predetermined time.

### TECHNICAL FIELD

The present invention relates to a medical image management system, where a photographing control apparatus for controlling photographing operation of a medical image photographing apparatus, and transferring medical image data generated by the photographing operation to a medical image management apparatus, a medical image management apparatus for storing and managing the medical image data transferred from the photographing control apparatus, and a medical image reproducing apparatus for reproducing and displaying the medical image data are connected through a network.

### BACKGROUND ART

In the medical field, where medical images taken of patients can be digitized, a medical image photographing apparatus (referred to hereinafter as a “modality”), such as a CR (Computed Radiography), CT (Computed Tomography) MRI (Magnetic Resonance Imaging), mammography, or ultrasonic/endoscopic apparatus, generates image data of medical images obtained by the photographing operation (hereinafter, “medical image data”).

Developments in the digitization of medical image have facilitated integration between different systems. For example, the PACS (Picture Archiving and Communication System) is known that comprises a server (a medical image management apparatus) for storing and managing the medical image data generated by a modality and a client terminal (a medical image reproducing apparatus) for reproducing and displaying the stored and managed medical image data.

A photographing control apparatus (referred to hereinafter as a “modality console”) is also known as an apparatus for controlling photographing operation of a modality (see, for example, Patent Document 1). The modality console controls when to start photographing by the modality, and successively transfers the medical image data obtained by the photographing operation to the PACS, according to an order from a system such as HIS (Hospital Information System) or RIS (Radiological Information System).

### (Patent Document 1: Japanese Patent Laid-Open No. 2002-219122)

### DISCLOSURE OF THE INVENTION

### The Problems to be Solved by the Invention

While medical image data generated by different modalities can be referenced semi-permanently, in medical practice, it is often referred at a particular time of day, such as immediately after photographing or surgery hours. However, as described in Patent Document 1, when medical image data generated by modalities is successively transferred to a server in PACS, intensive access will be made by clients to the server at particular times of day, which would result in degradation of the server's performance.

In addition, some of the medical image data that has been confirmed and checked by a user such as an imaging engineer at a modality console may not actually be referenced by a doctor who interprets radiograms. If such medical image data flows in the network at a particular time of day during which the medical images would be referenced more frequently, then a decrease in communication speed between a server and client terminals will result, which would increase the load on the network and result in waste of the network resources.

The present invention has been made in view of the above-mentioned problems, and an object of the invention is to reduce the network load on the medical image management system and allow more efficient use of the network resources.

### Means for Solving the Problems

To solve the problems, the invention of claim 1 provides:

a medical image management system in which a a photographing control apparatus, a medical image management apparatus, and a medical image reproducing apparatus are connected through a network, comprising:

the photographing control apparatus for controlling photographing operation of a medical image photographing apparatus, and transferring medical image data generated by the photographing operation to the medical image management apparatus;

the medical image management apparatus for storing and managing the medical image data transferred from the photographing control apparatus; and

the medical image reproducing apparatus for reproducing and displaying the medical image data,

the photographing control apparatus comprising:
a temporary storage section for, prior to transferring the medical image data to the medical image management apparatus, temporarily storing the medical image data generated by the medical image photographing apparatus; and
a transfer control section for reading and transferring, from the temporary storage section, the medical image data corresponding to a transfer request from the medical image reproducing apparatus, and

the medical image reproducing apparatus comprising:
an input section for inputting, according to a user's manipulation, a reproduction instruction to reproduce the medical image data generated by the medical image photographing apparatus; and
a reception control section for providing a transfer request of the medical image data, for which data the reproduction instruction is input by the input section, to receive the medical image data transferred from the photographing control apparatus.

According to claim 2, the invention of claim 1 is characterised in that:

the medical image reproducing apparatus further comprises:
a reproduction image storage section for temporarily storing the medical image data received by the reception control section.

According to claim 3, the invention of claim 1 or 2 is characterised in that:

the transfer control section transfers the medical image data corresponding to the transfer request to the medical image management apparatus, and

the medical image management apparatus further comprises:
a transmission control section for storing and managing the medical image data transferred from the photographing control apparatus, and for transmitting the medical image data to the medical image reproducing apparatus; and

the reception control section for receiving the medical image data transferred from the photographing control apparatus via the medical image management apparatus.

According to claim 4, the invention of any one of claims 1 to 3 is characterised in that:

the photographing control apparatus further comprises:
a deletion section for deleting the medical image data transferred by the transfer control section from the temporary storage section.

According to claim 5, the invention of any one of claims 1 to 4 is characterised in that:

the photographing control apparatus further comprises:
a transmission section for transferring the medical image data stored in the temporary storage section to the medical image management apparatus at a predetermined time of day.

According to claim 6, the invention of any one of claims 1 to 5 is characterised in that:

the photographing control apparatus further comprises:
a status transmission section for transmitting, to the medical image management apparatus, status information indicative of a progress status of the photographing operation by the medical image photographing apparatus,

the medical image management apparatus further comprises:
a list creation section for creating list data indicative of a progress status of the photographing operation for each of the medical image data; and
an update section for updating list data created by the list creation section based on the status information transmitted from the photographing control apparatus, and

the medical image reproducing apparatus further comprises:
a display section for displaying the list data created and updated by the medical image management apparatus.

### EFFECTS OF THE INVENTION

According to the invention of claim 1, a photographing control apparatus temporarily stores medical image data prior to transferring the medical image data to a medical image management apparatus, and transfers the medical image data in response to a reproduction instruction by a user at a medical image reproducing apparatus. This may prevent intensive access to the medical image management apparatus with every reproduction instruction when medical image data is transferred from the photographing control apparatus to the medical image reproducing apparatus. In addition, medical image data will not transferred to the medical image management apparatus with every photographing by the medical image photographing apparatus. Therefore, this may achieve reduction in the network load on the medical image management system as well as more efficient use of the network resources.

In addition, according to the invention of claim 2, it may, of course, provide the same advantages as the invention of claim 1, wherein medical image data is temporarily stored in a distributed manner in the photographing control apparatus and the medical image reproducing apparatus, respectively.

In addition, according to the invention of claim 3, it may, of course, provide the same advantages as the invention of claim 1 or 2, wherein the medical image management apparatus stores and manages medical image data transferred from the photographing control apparatus, and transmits the medical image data to the medical image reproducing apparatus. This allows medical image data to be transferred when a reproduction instruction is input, and allows it to be successively stored at the medical image management apparatus with every reproduction instruction.

In addition, according to the invention of claim 4, it may, of course, provide the same advantages as the invention of any one of claims 1 to 3, wherein the photographing control apparatus deletes the transferred medical image data from the temporary storage section, which causes image data that is temporarily stored at the photographing control apparatus to be distributed to the medical image management apparatus and the medical image reproducing apparatus.

In addition, according to the invention of claim 5, it may, of course, provide the same advantages as the invention of any one of claims 1 to 4, wherein medical image data may be transferred to the medical image management apparatus at times of day, other than those during which the medical images would be referenced more frequently, for example, thereby preventing increased load from being imposed on the network.

In addition, according to the invention of claim 6, it may, of course, provide the same advantages as the invention of any one of claims 1 to 5, wherein a progress status of photographing may be confirmed at the medical image management apparatus or the medical image reproducing apparatus without transmitting or receiving medical image data, because list data is updated based on status information transmitted in correspondence with the progress status of photographing by the medical image photographing apparatus.

### BRIEF DESCRIPTION OF THE DRAWINGS

FIG. 1 is a block diagram illustrating an example system configuration of a medical image management system;

FIG. 2 illustrates an example data configuration of medical image data;

FIG. 3 illustrates an example screenshot of an image selection screen;

FIG. 4 is a block diagram illustrating an example functional configuration of a server, a viewer, and a console;

FIG. 5A illustrates an example data configuration of a storage section included in the server according to a first embodiment;

FIG. 5B illustrates an example data configuration of a storage section included in each viewer according to the first embodiment;

FIG. 5C illustrates an example data configuration of a storage section included in each console according to the first embodiment;

FIG. 6A illustrates an example data configuration of list data;

FIG. 6B illustrates an example data configuration of status update instruction information;

FIG. 7 is a flowchart illustrating a specific operation of the medical image management system in the first embodiment;

FIG. 8 illustrates an example operation of the medical image management system in the first embodiment;

FIG. 9 illustrates an example data configuration of a storage section included in each viewer according to a second embodiment;

FIG. 10 is a flowchart illustrating a specific operation of a medical image management system according to a second embodiment; and

FIG. 11 illustrates an example operation of the medical image management system in the second embodiment.

### EXPLANATION OF REFERENCE NUMERAL

S Medical Image Management System
N Intra-Hospital Network
1 PACS
2 Server
3 Viewer
5 Modality
4 HIS, RIS
6 Console
20 Control Section
22 Input section
24 Display section
26 Storage Section
28 Communication Section
30 Control Section
32 Input section
34 Display section
36 Storage Section
37 Storage Section
38 Communication Section
60 Control Section
62 Input section
64 Display section
66 Storage Section
68 Communication Section
262 List Data
268 Status Information
360 List Data
662 Status Update Instruction Information
662b Status Information
370 Image Temporary Storage DB
660 Image Temporary Storage DB

### BEST MODE FOR CARRYING OUT THE INVENTION

### First Embodiment

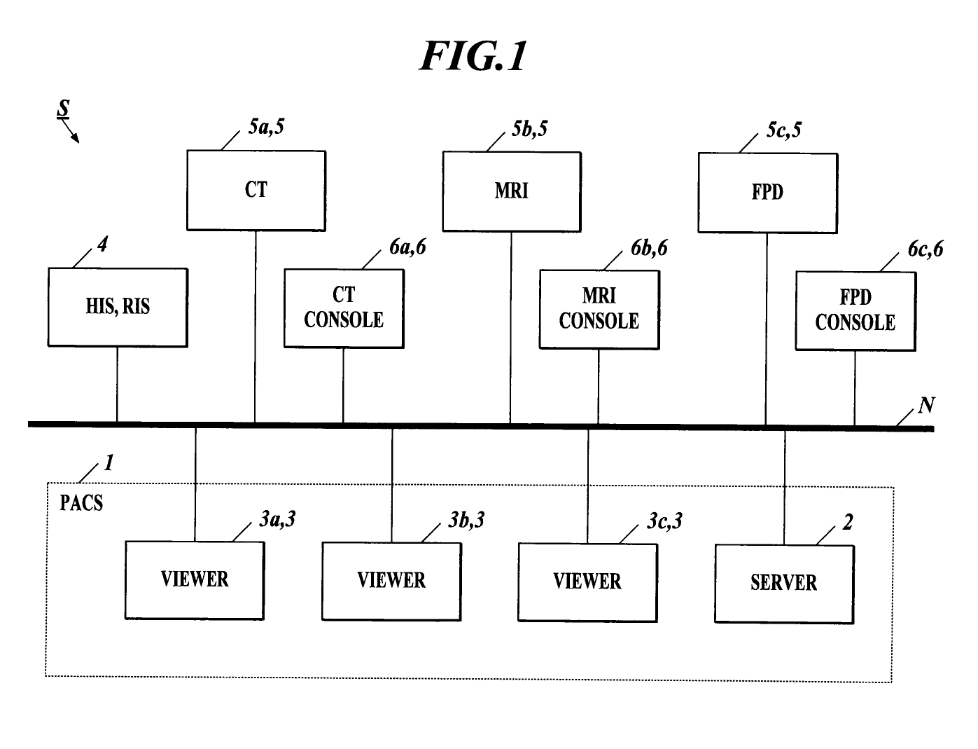

A first embodiment of a medical image management system according to the present invention will be described below with reference to FIGS. 1 to 8.

### <Medical Image Management System Overview>

Referring first to FIG. 1, an overview of a medical image management system S is given below. FIG. 1 is a block diagram illustrating an example system configuration of the medical image management system S. As illustrated in FIG. 1, the medical image management system S comprises a PACS 1; HIS, RIS 4; different modalities 5; and consoles 6 corresponding to the modalities 5, all connected to an intra-hospital network N.

The HIS (Hospital Information System) comprises a computer that has a CPU (Central Processing Unit), a storage section including ROM (Read Only Memory) and RAM (Random Access Memory), an input section, a display section, a communication section, etc. The HIS manages comprehensive hospital information, such as medical billing, appointment, electronic medical chart management, examination, or medicine orders to appropriate departments.

The RIS (Radiological Information System) comprises a computer that has a CPU, a storage section, an input section, a display section, a communication section, etc. The RIS manages comprehensive information of the radiology system: it manages information in the radiology department, such as appointments, diagnosis reports, medical records, or material inventory management.

The HIS, RIS 4 accepts a photographing order from a doctor and generates order information including the content of the order. Then, the order information is transmitted to a console 6 and a server 2 in question via the intra-hospital network N. The order information is such data that contains patient information of a patient to be photographed, such as name, ID, or sex, and examination information indicative of examination conditions, such as an examination ID that identifies the examination ordered by a doctor, examination parts, photographing directions, or patient positions.

The modalities 5 convert the data signals of the images that are photographed according to the manipulation by imaging engineers into digital data compliant with the DICOM standard, thereby generating and transmitting medical image data to the PACS 1. The modalities include a CT 5a, an MRI 5b, and an FPD 5c as illustrated in FIG. 1, as well as a CR, mammography apparatus, ultrasonic diagnosis apparatus, etc.

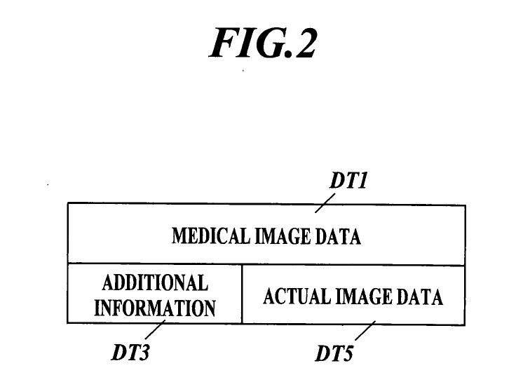

FIG. 2 illustrates an example data configuration of medical image data DT1. As illustrated in FIG. 2, the medical image data DT1 comprises additional information DT3 and actual image data DT5. The actual image data DT5, which is image data for the image of an object photographed by a modality 5, is provided in a data format compliant with the DICOM standard.

The additional information DT3 comprises an AE (Application Entity) title identifying a modality 5 that generates medical image data DT1, patient information such as patient IDs, patient names, or birth dates, and examination information such as examination IDs, examination dates and times, or examination parts. For example, the additional information DT3 includes such data that is described under the DICOM standard based on the order information received from the HIS, RIS 4.

Each of the modalities has a console 6. The consoles 6 are photographing control apparatuses that control photographing operations of the different modalities 5, such as when to start or end the photographing operation, and transfers the medical image data DT1 generated at the modalities 5. The consoles 6 are configured to be able to communicate data with the modalities 5 either directly or through the intra-hospital network N. As illustrated in FIG. 1, the consoles 6 include a CT console 6a for controlling photographing operation of the CT 5a, an MRI console 6b for controlling photographing operation of the MRI 5b, an FPD console 6c for controlling photographing operation of the FPD 5c, and so on.

For example, a modality 5 and a console 6 corresponding to that modality 5 are provided as a combined pair: the CT console 6a is provided adjacent to the CT 5a, and so on. A user, such as an imaging engineer, manipulates a console 6 to provide instructions to start and end the photographing operation of the modality 5. In addition, the console 6 reproduces and displays the medical image data DT1 generated by the modality 5, and performs image processing on the medical image data DT1 according to user instructions.

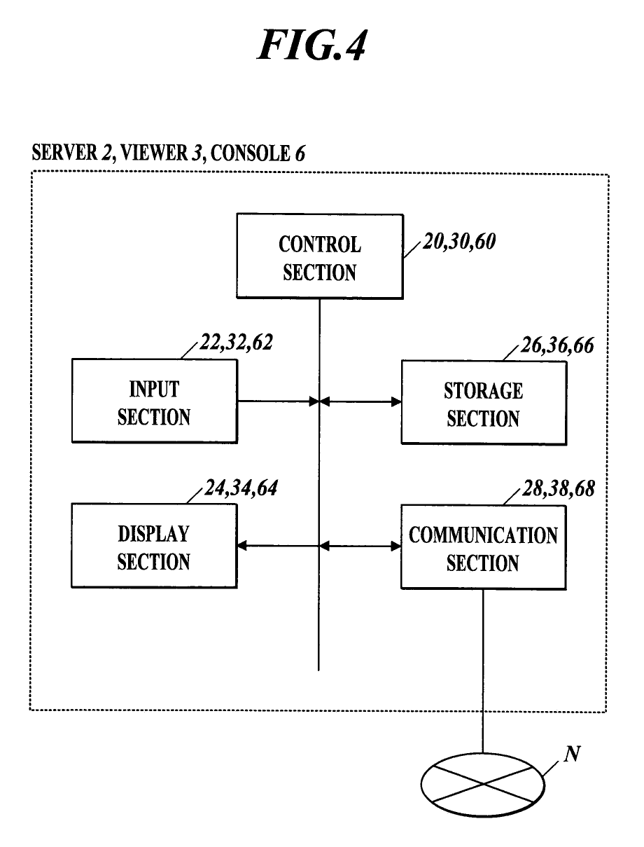

For example, after the reproduced and displayed medical image is confirmed and checked, the medical image data DT1 is temporarily stored in a storage section 66 (see FIG. 4) of the console 6 when an instruction is input by a user through manipulation of an input section 62 (see FIG. 4) to complete the confirmation. The medical image data DT1 temporarily stored at the console 6 is transmitted in response to requests from a viewer 3 and a server 2 in the PACS 1, and collectively transmitted to the server 2 at predefined times of day (e.g., between 0:00 and 5:00 am).

In addition, the console 6 manages the progress status (referred to hereinafter as “status”) of photographing (examination) by the modality 5 to notify the server 2 in the PACS 1 of the status.

The PACS 1 comprises a server 2 for storing and managing medical image data DT1 generated at the modalities 5, and a plurality of viewers (clients) 3 for reproducing and displaying the medical image data DT1.

The server 2 is a medical image management apparatus that makes a database of the medical image data DT1 generated by the modalities 5 and that stores and manages the medical image data DT1 in the database. Since the medical image data DT1 generated at a modality 5 is temporarily stored in the corresponding console 6 as described above, the medical image data DT1 of interest is obtained from the console 6 upon input of a reproduction and display instruction at a viewer 3. Then, the obtained medical image data DT1 is stored at the server 2 and transmitted to the corresponding viewer 3.

In addition, the server 2 creates a complete list of the different information about the medical images photographed at the different modalities 5, based on the order information transmitted from the HIS, RIS 4 and a notification of the status change from the console 6. The created list is delivered to the consoles 6 and the viewers 3.

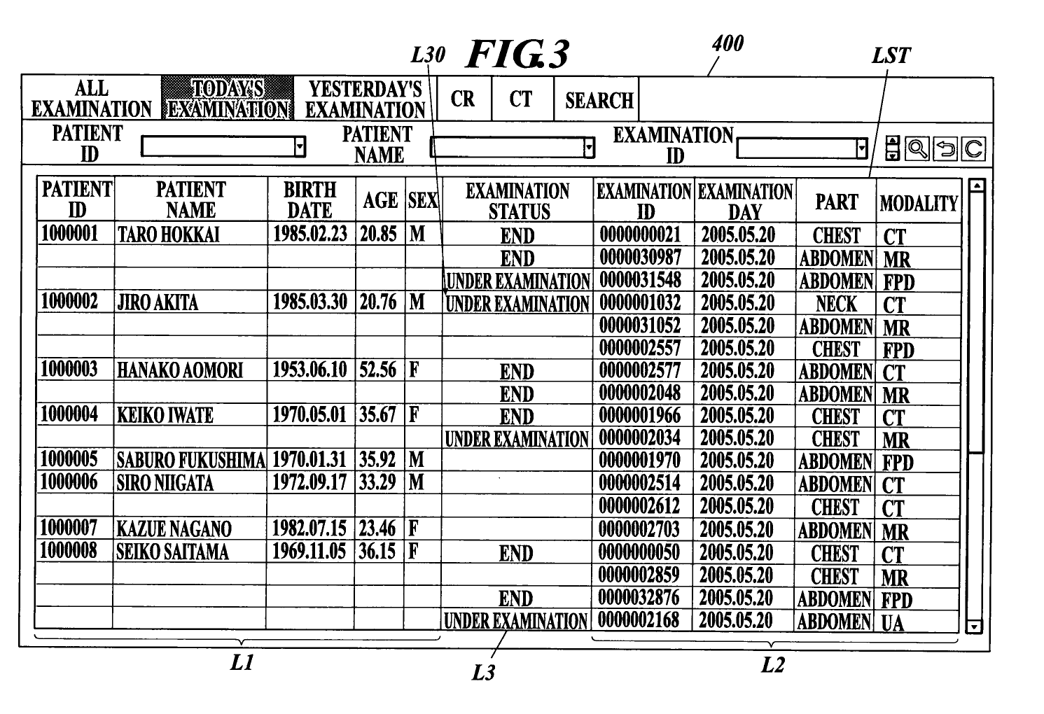

FIG. 3 illustrates an example screenshot of an image selection screen 400 in which a complete list LST is displayed. As illustrated in FIG. 3, the complete list LST comprises: patient information section L1 for displaying patient information, such as patient IDs, patient names, birth dates, ages or sexes; examination information section L2 for displaying examination information, such as examination IDs, examination days, examination parts, or modalities; and examination status section L3.

The examination status section L3, which is a section for displaying the status of the examination indicated by examination ID, displays the status of “END” when the examination has already been completed, “UNDER EXAMINATION” when the examination is in progress, and soon. For example, it can be seen from FIG. 3 that the examination corresponding to examination ID “0000000021” is performed at the CT 5a and that it has already been completed because its examination status denotes “END”.

The viewers 3 are medical image reproducing apparatuses that comprise an LCD (Liquid Crystal Display), etc., and reproduce and display medical images based on medical image data DT1. Each of the viewers 3 obtains and displays list data (described below) from a server 2 for displaying the complete list LST, as illustrated in FIG. 3. Upon selection of a desired examination ID by a user, the medical image data DT1 corresponding to the examination ID is transferred to the user via the server 2, and the medical image data DT1 is reproduced and displayed.

That is, such a client-server system is achieved by the server 2 and the viewers 3, wherein distributed functions are provided for storing and managing the medical image data DT1 and for reproducing and displaying the medical image data DT1, respectively.

### <Console, Server, and Viewer Functional Configuration>

Referring now to FIGS. 4 to 6, a functional configuration of a server 2, a viewer 3, and a console 6 will be described below. Note that the server 2, the viewer 3, and the console 6 may be implemented with general-purpose computers and their main components are the same. Thus, the block diagram of FIG. 4 illustrates a representative functional configuration.

### <Server>

The server 2 comprises a control section 20, an input section 22, a display section 24, a storage section 26, and a communication section 28. The control section 20, which includes a CPU, ROM, RAM, etc, comprehensively manages and controls the server 2 by controlling operation of respective functional parts, data input and output between the functional parts, and so on.

Specifically, the control section 20 reads program stored in the ROM or the storage section 26 in response to a manipulation signal input from the input section 22, and performs operations according to the program. Then, based on the operation results, it performs other operations, such as updating the display screen of the display section 24, storing data in the storage section 26, or communicating data with external devices.

The input section 22 comprises different groups of keys, such as cursor keys or numeric keys, and a pointing device, such as a mouse or touch panel. The input section 22 outputs to the control section 20 operation signals that correspond to the keys pressed by a user and to the coordinate positions on the screen specified by a pointing device.

The display section 24, which comprises a CRT (Cathode-ray Tube), an LCD, etc., displays a screen based on the control of the control section 20. The communication section 28, which comprises a LAN interface, etc., is a functional part for communicating data between a viewer 3 and a console 6 via the intra-hospital network N.

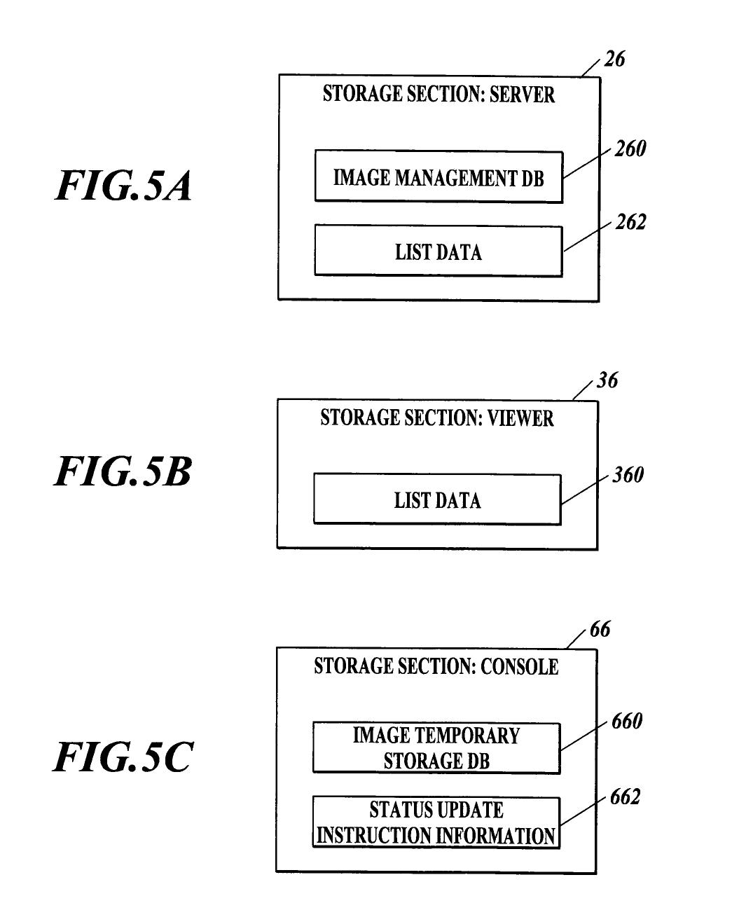

The storage section 26, which comprises an HDD (Hard Disk Drive), etc., is a functional part for reading data from and writing data to a magnetic or optical storage medium. FIG. 5A illustrates an example data configuration of the storage section 26. As illustrated in FIG. 5A, the storage section 26 stores an image management DB 260 and list data 262.

The image management DB 260 is a database that accumulates and stores the medical image data DT1 received from a console 6. Upon receipt of medical image data DT1 generated by a modality 5 via the corresponding console 6, the control section 20 stores it in the image management DB 260 so that it can be retrieved later based on the additional information DT3 contained in the medical image data DT1.

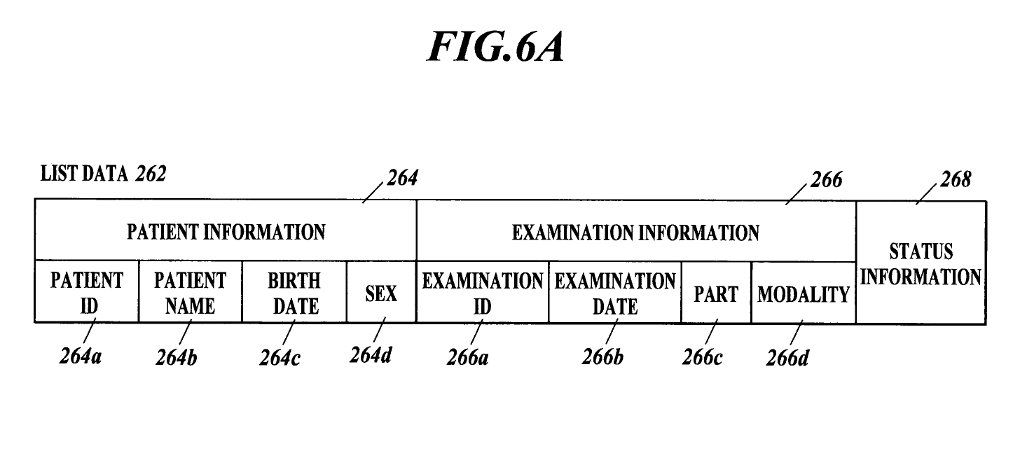

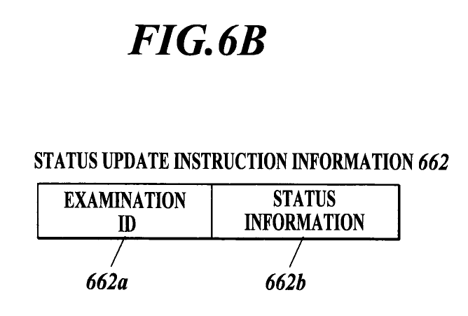

The list data 262, which is a display data for displaying the complete list LST illustrated in FIG. 3, is configured with the data configuration as illustrated in FIG. 6A. That is, the list data 262 is configured with patient information 264 including patient ID 264a, patient name 264b, birth date 264c, and sex 264d, examination information 266 including examination ID 266a, examination date 266b, part 266c, and modality type 266d, and status information 268.

The patient information 264 and the examination information 266 of the list data 262 are set based on order information transmitted from the HIS, RIS 4. Upon receipt of the order information from the HIS, RIS 4, the control section 20 extracts the patient information 264 and the examination information 266 from the order information to accumulate and store them in the list data 262.

The status information 268 is such data that indicates the progress status of the examination indicated by the patient information 264 and the examination information 266 corresponding to the status information 268. When the patient information 264 and the examination information 266 are stored in the list data 262, invalid data is stored in the status information 268 as initial data.

Then, when data is transmitted from a console 6 to the server 2 indicating that the examination has been started (status update instruction information 662, described below), the status information 268 in the list data 262 is updated to indicate that the examination is in progress. In addition, when data is transmitted from the console 6 to the server 2 indicating that the examination has been completed, the status information 268 is updated to indicate the completion of the examination.

### <Viewers>

As illustrated in FIG. 3, each viewer 3 in the PACS 1 comprises a control section 30, an input section 32, a display section 34, a storage section 36, and a communication section 38. Note that the respective functional parts of the viewers 3 have the same configuration as those of the server 2, and so will not be described in detail below.

FIG. 5B illustrates an example data configuration of the storage section 36 in each viewer 3. As illustrated in FIG. 5B, the storage section 36 stores list data 360. The list data 360 has the same data configuration as that of the list data 262 stored at server 2 side.

Each time list data 262 is updated at server 2 side, the updated list data 262 is transmitted to the viewers 3. Based on the list data 360, the viewers 3 can also display the same complete list LST as the server 2, illustrated in FIG. 3.

A user references this complete list LST to select a list to be reproduced and displayed. If the status information 268 corresponding to the list selected based on the operation signals from the input section 32 is invalid data, or if it indicates that the examination is in progress, the control section 30 causes the display section 34 to display a message that the medical image data DT1 corresponding to the list cannot be reproduced.

In addition, if the status information 268 indicates that the examination has been completed, then the control section 30 requests transmission of the medical image data DT1 by extracting a patient ID 264a and an examination ID 266a of the medical image data DT1 from the list data 360 and transmitting them to the server 2.

At this point, at server 2 side, the medical image data DT1 containing the patient ID 264a and the examination ID 266a is read from the image management DB 260 or obtained from a console 6, and then transmitted to a viewer 3. At viewer 3 side, the medical image data DT1 transmitted from the server 2 is reproduced and displayed on the display section 34.

### <Consoles>

As illustrated in FIG. 3, each console 6 comprises a control section 60, an input section 62, a display section 64, a storage section 66, and a communication section 68. The respective functional parts of the consoles 6 have substantially the same configuration as those of the server 2.

While the communication section 68 in each console 6 comprises a LAN interface or the like as in the server 2 and the viewers 3, for example, it may comprise a serial interface to receive medical image data DT1, directly communicating data with a modality 5.

FIG. 5C illustrates an example data configuration of the storage section 66 in each console 6. As illustrated in FIG. 5C, the storage section 66 stores an image temporary storage DB 660 and status update instruction information 662.

The image temporary storage DB 660 is a database that temporarily stores medical image data DT1 received from a modality 5. Specifically, medical image data DT1 generated by a modality 5 is stored in the database so that it can be retrieved later based on the additional information DT3 contained in the medical image data DT1.

Upon request by the server 2 to transmit the medical image data DT1, the control section 60 reads the specified medical image data DT1 from the image temporary storage DB and transmits it to the server 2, while deleting the transmitted medical image data DT1 from the image temporary storage DB 660.

In addition, when the current time reaches a predetermined time of day (e.g., 0:00 am), the control section 60 transmits the all medical image data DT1 stored in the image temporary storage DB 660 to the server 2. Preferably, the times of day for transmitting medical image data DT1 are set to the ones during which the intra-hospital network N would have a less communication load, e.g., late at night, such as 0:00 to 3:00 am, when the medical image data DT1 would be less frequently referenced, and so on.

Consequently, among the medical image data DT1 stored in the image temporary storage DB 660, such medical image data DT1 requested by the server 2 will be successively transmitted to the server 2, while other medical image data DT1 without being requested will be transmitted to the server 2 at a predetermined time of day.

The status update instruction information 662 comprises examination ID 662a and status information 662b, as in the example data configuration of FIG. 6E. The status update instruction information 662 is such data for instructing update of the status information 268 in the list data 262 stored at the server 2. The status information 662b is such data that indicates the progress status of photographing and examination by a modality 5.

Upon receipt of order information from the HIS, RIS 4, the control section 60 schedules the photographing and examination of the modality 5 based on that order information. Then, according to the scheduling, the control section 60 outputs a photographing start instruction to the modality 5 via the communication section 68, causing the modality 5 to perform the photographing and examination.

The control section 60 controls the photographing and examination of the modality 5 and generates status information 662b corresponding to the progress status. Then, it associates examination ID 662a with status information 662b of the examination performed at the modality 5 to provide status update instruction information 662, which is in turn transmitted to the server 2 in the PACS 1. At this point, based on the status update instruction information 662 transmitted from the corresponding console 6, the status information 268 in the list data 262 is updated at the server 2.

Specifically, when the modality 5 starts photographing, the status update instruction information 662 including the status information 662b indicative of the start of the examination is transmitted to the server 2. In addition, when the photographing is completed, the medical image data DT1 generated by the photographing is stored in the image temporary storage DB 660, and the status update instruction information 662 including the status information 662b indicative of the completion of the examination is transmitted.

On the other hand, upon receipt of the status update instruction information 662, the server 2, to which the status update instruction information 662 is transmitted, searches the list data 262 for examination information 266 that includes the examination ID 662a in the status update instruction information 662. Then, the server 2 overwrites and updates the status information 268 associated with the examination information 266 with the received status information 662b.

That is, when the console 6 starts photographing a medical image, the status information 268 in the list data 262 is rewritten to data indicating that the examination is in progress through transmission and reception of the status update instruction information 662; whereas when the photographing is completed, the status information 268 is rewritten to data indicating that the examination is completed. Consequently, the status information 268 in the list data 262 is updated through transmission and reception of the status update instruction information 662, without transmitting or receiving any medical image data DT1, which allows the progress status of the examination to be managed and displayed at server 2 side.

### <Specific Operation of Medical Image Management System>

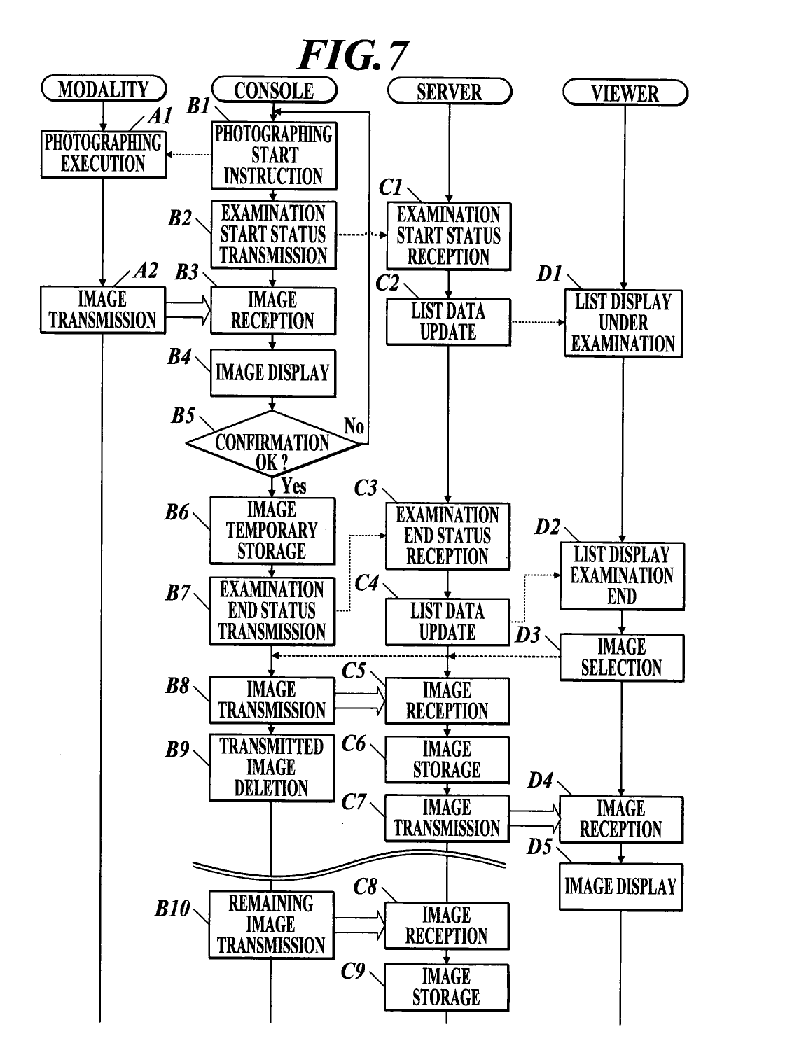

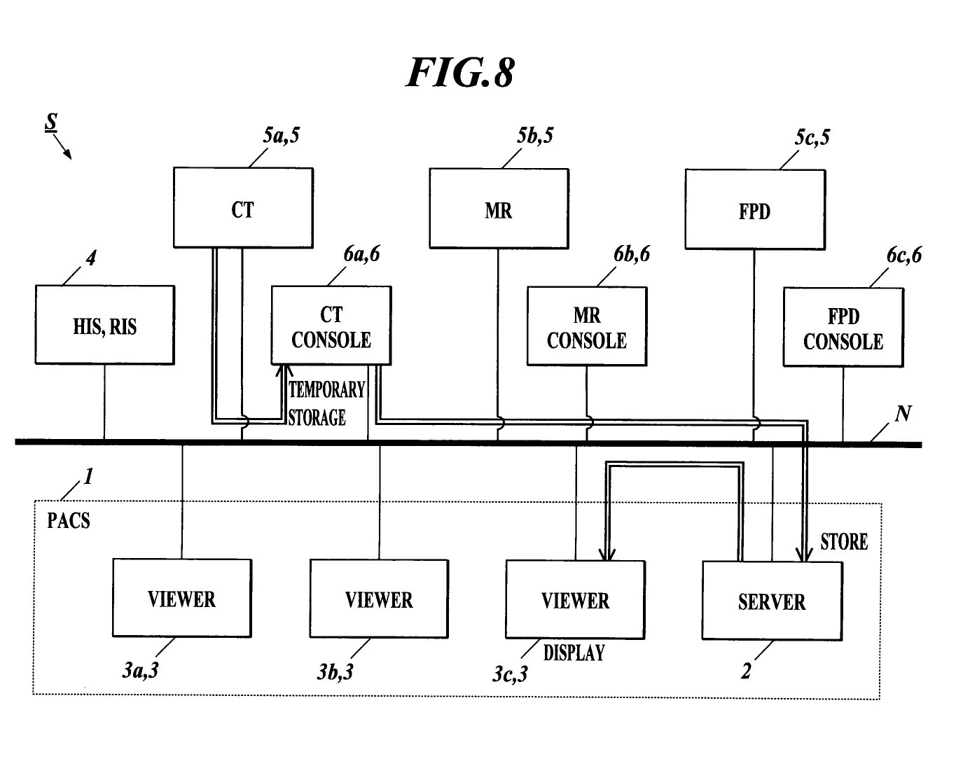

Referring now to FIGS. 7 and 8, a specific operation of the medical image management system S will be described below. FIG. 7 is a flowchart illustrating a specific operation of the medical image management system S; and FIG. 8 illustrates an example operation of the medical image management system S. Note that while the operations illustrated in the flowchart of FIG. 7 are performed by the control sections of a modality 5, a console 6, a server 2, and a viewer 3, respectively, for ease of description, the following description is given from the viewpoint of these apparatuses.

Firstly, the console 6 transmits a photographing start instruction to a modality 5 in question based on order information received from the HIS, RIS 4 (step B1), and transmits status update instruction information 662 indicative of the start of the examination to the server 2 (step B2).

The server 2 generates list data 262 based on order information received from the HIS, RIS 4 and transmits the list data 262 to a viewer 3, causing the viewer 3 to display the image selection screen 400 as illustrated in FIG. 3.

Then, if status update instruction information 662 is received from the console 6 (step C1), the server 2 updates the list data 262 based on the status update instruction information 662 (step C2). The server 2 then transmits the updated list data 262 to the viewer 3 (step C2), causing the viewer 3 to update the image selection screen 400 (step D1).

In FIG. 8, the CT console 6a instructs the CT 5a to start photographing, and the status update instruction information 662 is transmitted from the CT console 6a to the server 2. At this point, given that the status update instruction information 662 received at the server 2 has examination ID 662a of ‘0000001032’ and status information 662b of “UNDER EXAMINATION”, then the status information of the list data is rewritten based on the status information 662b, and the examination status L30 with examination ID of ‘0000001032’ is updated to indicate “UNDER EXAMINATION”, as illustrated in FIG. 3.

Then, upon completion of the photographing of the medical image at the modality 5, the medical image data DT1 is transmitted to the console 6 as with the CT 5a and the CT console 6a in FIG. 8 (step A2). Upon receipt of the medical image data DT1 (step B3), the console 6 causes the display section 64 to display the medical image based on the medical image data DT1 (step B4), and waits for any confirmation operation by the user (step B5).

After the user confirms the validity of the additional information, contrast, etc., to make any modification with reference to the displayed medical image, he/she manipulates the input section 62 to enter an input indicating that the confirmation of the medical image is completed. If manipulation of the input section 62 by the user is detected (“Yes” at step B5), then the console 6 temporarily stores the displayed medical image data DT1 in the image temporary storage DB 660 (step B6).

In addition, if at step B5 a rephotographing instruction is input via the input section 62 (“No” at step B5), then the process proceeds to step B1 where a photographing start instruction is again transmitted to the modality 5.

Once the medical image data DT1 is stored in the image temporary storage DB 660, the console 6 combines the examination ID 662a included in the additional information DT3 of the medical image data DT1 with the status information 662b indicative of the completion of the examination to generate status update instruction information 662, which is in turn transmitted to the server 2 (step B7).

Upon receipt of the status update instruction information 662 from the console 6 (step C3), the server 2 updates the list data 262 based on the status update instruction information 662 (step C4), and transmits the list data 262 to the viewer 3, causing the viewer 3 to update the image selection screen 400 (step D2).

In FIG. 8, given that the status update instruction information 662 has examination ID 662a of ‘0000001032’ and status information 662b of “EXAMINATION END” when the CT 5a completes the photographing operation and the status update instruction information 662 is transmitted from the CT console 6a to the server 2, then the list data 262 is rewritten based on the status information 662b, and the examination status L30 of “UNDER EXAMINATION” illustrated in FIG. 3 is updated to indicate “EXAMINATION END”.

If the user at viewer 3 side selects a medical image with the examination status L30 of “EXAMINATION END” on the image selection screen 400, i.e., the one with the examination information 266 associated with the status information 268 indicative of the completion of the examination in the list data 262, then the viewer 3 requests the server 2 to transmit the medical image by transmitting the examination ID 266a of the selected medical image (step D3).

Upon receipt of the request from the viewer 3 to transmit the medical image, the server 2 searches the image management DB 260 for medical image data DT1 corresponding to the received examination ID. At this point, if the medical image data DT1 corresponding to the examination ID is retrieved, then the medical image data DT1 is transmitted to the viewer 3, whereas if the medical image data DT1 cannot be retrieved because it is not stored in the image management DB 260, then the server 2 requests the console 6 to transmit the medical image by transmitting the examination ID, as in the viewer 3.

Upon receipt of the request from the server 2 to transmit the medical image, the console 6 searches the image temporary storage DB 660 for medical image data DT1 that contains the received examination ID in additional information DT3, which data is then transmitted to the server 2, as in the CD console 6 of FIG. 8 (step B8). Then, the transmitted medical image data DT1 is deleted from the image temporary storage DB 660 (step B9).

Upon receipt of the medical image data DT1 from the console 6 after requesting transmission of the medical image (step C5), the server 2 stores the medical image data DT1 in the image management DB 260 (step C6), and transmits the medical image data DT1 to the viewer 3, as in FIG. 8 (step C7).

Upon receipt of the medical image data DT1 from the server 2 after requesting transmission of the medical image at step D3 (step D4), the viewer 3 causes the display section 34 to display the medical image based on the medical image data DT1 (step D5).

On the other hand, the console 6 clocks the time, and it transmits the all medical image data DT1 stored in the image temporary storage DB 660 to the server 2 when the current time reaches a predetermined time of day (step B10). At this point, the server 2 stores the medical image data DT1 received from the console 6 in the image management DB 260 (steps C8 to C9).

As can be seen from the above, according to the first embodiment, medical image data DT1 will not be successively transmitted to a server 2 each time a medical image is photographed because a console 6 transmits status update instruction information 662 corresponding to the progress status of photographing by a modality S to the server 2, and the medical image data DT1 will be collectively transmitted to the server 2 at predetermined times of day, such as late at night. This may prevent increased load from being imposed on the intra-hospital network N at those times of day, such as surgery hours, during which the network load tends to be higher.

In addition, when an instruction is input at viewer 3 side to reference a medical image, the medical image data DT1 is transmitted from the console 6 to the server 2, which may reduce the communication load between the server 2 and the console 6 at times of day, such as surgery hours, preventing degradation in performance of the server 2. Therefore, this may achieve reduction in the network load on the medical image management system S as well as more efficient use of the network resources.

### Second Embodiment

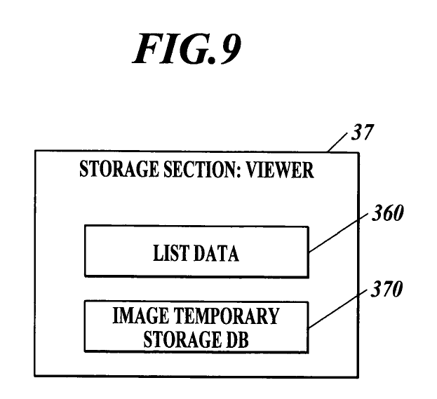

Referring now to FIGS. 9 to 11, a second embodiment of the medical image management system S will be described below. The medical image management system in the second embodiment S has substantially the same system configuration as that described in the first embodiment.

In addition, a viewer 3 in the second embodiment is implemented with such a configuration where the storage section 36 illustrated in FIG. 5B is replaced with a storage section 37 illustrated in FIG. 9, while a server 2 and a console 6 are implemented with substantially the same functional configuration as that of the apparatuses described in the first embodiment. Accordingly, in the following description, the same reference numerals will be used to refer to the same components as the first embodiment and description thereof will be omitted.

As illustrated in FIG. 9, the storage section 37 of each viewer 3 stores list data 360 and an image temporary storage DB 370. The image temporary storage DB 370 is a database that temporarily stores medical image data DT1 received from a console 6.

When an instruction is input by a user through manipulation of the input section 32 to view a medical image, the control section 30 requests the console 6 to transmit medical image data DT1. Then, upon receipt of the medical image data DT1 transmitted from the console 6, the medical image is displayed based on the medical image data DT1, which is then temporarily stored in the image temporary storage DB 370.

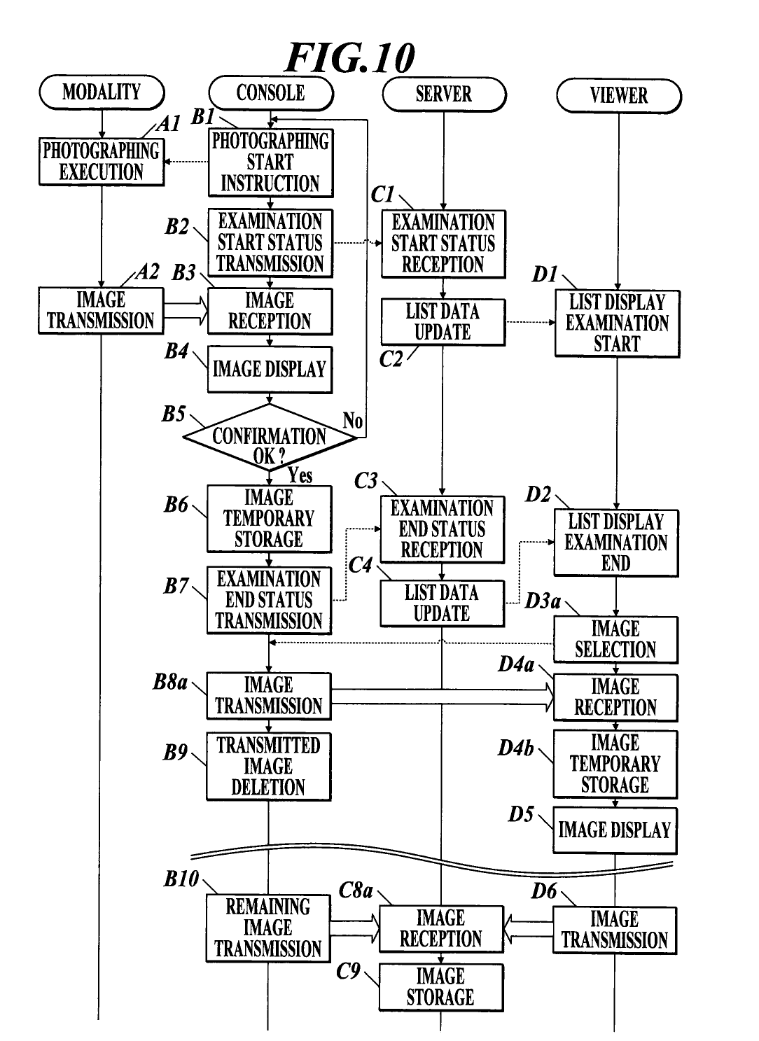

FIG. 10 is a flowchart illustrating a specific operation of the medical image management system in the second embodiments. Note that, in FIG. 10, the same process steps are denoted by the same step numbers as those used in the medical image management system S in the first embodiment illustrated in FIG. 7, and so will not be described in detail below.

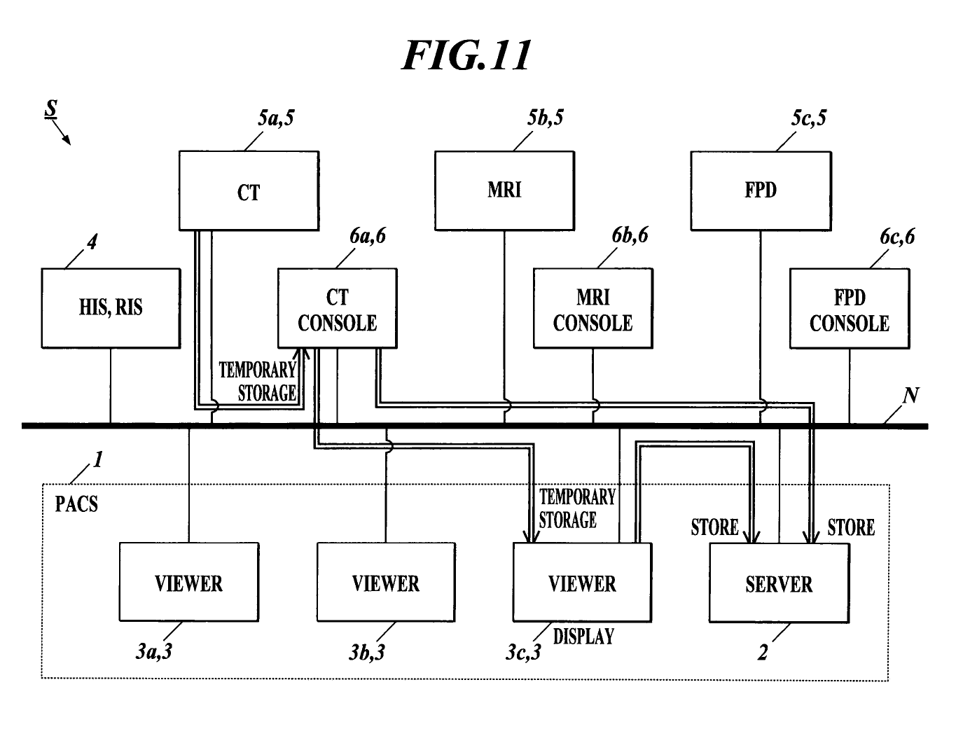

Firstly, in the flowchart of FIG. 10, a modality 5 performs photographing operation based on photographing start instructions from consoles 6, and transmits the generated medical image data DT1 to the respective consoles 6, such as from a CT 5a to a CT console 6a in FIG. 11 (steps A1 to A2).

Each of the consoles 6 transmits a photographing start instruction to the corresponding modality 5 based on order information transmitted from HIS, RIS 4, and transmits status update instruction information 662 indicative of the start of the examination to the server 2 (steps B1 to B2).

Then, if a confirmation input is entered by a user after the medical image data DT1 transmitted from the modality 5 is received, reproduced and displayed by the console, then the console stores the medical image data DT1 in the image temporary storage DB 660 and transmits status update instruction information 662 indicative of the completion of the examination to the server 2 (steps B3 to B7).

Upon receipt of the status update instruction information 662 from the console 6, the server 2 updates list data 262 based on the status update instruction information 662, and transmits it to the viewer 3 (steps C1 to C2 and C3 to C4).

If a medical image is selected on the image selection screen 400 in response to manipulation of the input section 32 after an image selection screen 400 is displayed based on the list data 262 transmitted from the server 2 (steps D1 and D2), then the viewer 3 transmits the examination ID of the selected medical image to the console 6 to request transmission of the medical image data DT1 (step D3a).

At this point, the console 6 searches the image temporary storage DB 660 for medical image data DT1 that contains the examination ID received from the viewer 3 in the examination information of the additional information, which data is then transmitted to the viewer 3, as in the CT console 6a in FIG. 11 (step B8a), and then deleted from the image temporary storage DB 660 (step B9).

Note that when the console 6 searches the image temporary storage DB 660 for any medical image data DT1 containing the received examination ID, and if such medical image data DT1 is not stored therein, then the console 6 may request the server 2 to transmit the medical image data DT1 as in step D3a.

Upon receipt of the medical image data DT1 transmitted from the console 6 (step D4a), the viewer 3 temporarily stores the medical image data DT1 in the image temporary storage DB 660 at viewer 3 side (step D4b), and reproduces and displays the medical image (step D5).

On the other hand, the console 6 clocks the time, and it transmits the all medical image data DT1 stored in the image temporary storage DB 660 to the server 2 when the current time reaches a predetermined time of day (step B10). In addition, the viewer 3 also clocks the time, and it transmits all the medical image data DT1 stored in the image temporary storage DB 370 to the server 2 when the current time reaches a predetermined time of day (step D6).

At this point, the server 2 stores the respective medical image data DT1 received from the console 6 and the viewer 3, such as the CT console 6a and the viewer 3 in FIG. 11, in the image management DB 260 (steps C8a to C9).

As can be seen from the above, according to the second embodiment, a console 6 transmits medical image data DT1 to a viewer 3 upon request by the viewer 3 to transmit the medical image data DT1, without intervention by a server 2, when referencing a medical image. This may prevent degradation in performance of the server 2. In addition, the medical image data DT1, for which a transmission instruction is provided, will be deleted from the console 6 and temporarily stored at the viewer 3, which may also reduce the load on the console 6. Therefore, this may achieve reduction in network load on the medical image management system S as well as more efficient use of the network resources.

Note that while the second embodiment has been described in the context of a viewer 3 receiving medical image data DT1 by directly instructing a console 6 to transmit that data, a viewer 3 may receive medical image data DT1 via a server 2 by instructing transmission of that data DT1 via the server 2, as in the first embodiment. In this case, as in the first embodiment, the server 2 may store medical image data DT1 that it relays in the image management DB 260, allowing reduction in the number of pieces of medical image data DT1 that would be transmitted by viewers 3 and consoles 6 at predetermined times of day.

While the second embodiment has also been described in the context of a console 6 transmitting medical image data DT1 at step B8a, and then deleting the medical image data DT1 from the image temporary storage DB 660, the following scenario may be possible: A console 6 temporarily stores, rather than deleting, the medical image data DT1 transmitted at step B8a, which is then transmitted to the server 2 at step B10. In this case, the viewer 3 does not need to temporarily store the received medical image data DT1 for transmission to the server 2. In addition, temporal storage of medical image data DT1 is only performed at a console 6, which may simplify the operation of the medical image management system S.

### INDUSTRIAL APPLICABILITY

The present invention can be used in the medical field and applied to any medical image management systems including modalities, viewers, servers, etc.

1-6. (canceled)

7. A medical image management system in which a photographing control apparatus, a medical image management apparatus, and a medical image reproducing apparatus are connected through a network, comprising:
the photographing control apparatus for controlling photographing operation of a medical image photographing apparatus, and transferring medical image data generated by the photographing operation to the medical image management apparatus;
the medical image management apparatus for storing and managing the medical image data transferred from the photographing control apparatus; and
the medical image reproducing apparatus for reproducing and displaying the medical image data,
the photographing control apparatus comprising:
a temporary storage section for, prior to transferring the medical image data to the medical image management apparatus, temporarily storing the medical image data generated by the medical image photographing apparatus; and
a transfer control section for reading and transferring, from the temporary storage section, the medical image data corresponding to a transfer request from the medical image reproducing apparatus, and
the medical image reproducing apparatus comprising:
an input section for inputting, according to a user's manipulation, a reproduction instruction to reproduce the medical image data generated by the medical image photographing apparatus; and
a reception control section for providing the transfer request of the medical image data, for which data the reproduction instruction is input by the input section, to receive the medical image data transferred from the photographing control apparatus.

8. The medical image management system according to claim 1, wherein the medical image reproducing apparatus further comprises:
a reproduction image storage section for temporarily storing medical the image data received by the reception control section.

9. The medical image management system according to claim 1, wherein
the transfer control section transfers the medical image data corresponding to the transfer request to the medical image management apparatus, and
the medical image management apparatus further comprises:
a transmission control section for storing and managing the medical image data transferred from the photographing control apparatus, and for transmitting the medical image data to the medical image reproducing apparatus; and
the reception control section for receiving the medical image data transferred from the photographing control apparatus via the medical image management apparatus.

10. The medical image management system according to claim 1, wherein the photographing control apparatus further comprises:
a deletion section for deleting the medical image data transferred by the transfer control section from the temporary storage section.

11. The medical image management system according to claim 1, wherein the photographing control apparatus further comprises:
a transmission section for transferring the medical image data stored in the temporary storage section to the medical image management apparatus at a predetermined time of day.

12. The medical image management system according to claim 1, wherein
the photographing control apparatus further comprises:
a status transmission section for transmitting, to the medical image management apparatus, status information indicative of a progress status of the photographing operation by the medical image photographing apparatus,
the medical image management apparatus further comprises:
a list creation section for creating list data indicative of a progress status of the photographing operation for each of the medical image data; and
an update section for updating list data created by the list creation section based on the status information transmitted from the photographing control apparatus, and
the medical image reproducing apparatus further comprises:
a display section for displaying the list data created and updated by the medical image management apparatus.
